(19) United States
(12) Patent Application Publication
(10) Pub. No.: US 2008/0276784 A1
(43) Pub. Date: Nov. 13, 2008

(54) MITER SAW AND A BEVEL LOCK DEVICE THEREOF

(75) Inventor: Changning Zhang, Nanjing (CN)

Correspondence Address: GREENBERG TRAURIG, LLP, 77 WEST WACKER DRIVE, SUITE 2500, CHICAGO, IL, 60601-1732, US

(73) Assignee: CHERVON LIMITED, Kwai Chung (HK)

(21) Appl. No.: 12/109,488

(22) Filed: Apr. 25, 2008

(30) Foreign Application Priority Data
May 8, 2007 (CN) 200720037479.1

(51) Int. Cl. B26D 7/26; B26D 1/16; B26D 5/08

(52) U.S. Cl. 83/699.51; 83/471.3; 83/581

(57) ABSTRACT

A miter saw has a base and a rotatable table mounted on the base. A support is mounted on the rear of the table. A pivot arm is pivotally connected to the support through a connecting shaft. A cutting assembly is connected to the pivot arm. A locking member is connected between the support and the pivot arm. An electromagnetic member is connected to the locking member through a linking device. The electromagnetic member is electrically connected to a switch which is used to control a supply of actuating power to the electromagnetic member.

### BACKGROUND

The subject application generally relates to a power tool which has a rotary circular blade for cutting and which is able to perform bevel cutting and, more particularly, relates to a bevel lock device of such a power tool for locking the blade in a desired position.

Generally, a miter saw comprises a base for supporting a workpiece and a rotatable table mounted on the base. The table has a supporting surface and is rotatable around a central line which is perpendicular to the supporting surface. A support is mounted on the rear of the table. A pivot arm is connected to the support and is pivotal around a first axis which lies approximately in the supporting surface and is approximately perpendicular to a rotation axis of a blade. A cutting assembly is connected to the pivot arm and is pivotal around a second axis between a lower cutting position and a higher at-rest position. The second axis is approximately parallel to the rotation axis of the blade. The miter angle of the table is adjusted relative to the base and the bevel angle of the pivot arm is adjusted relative to the table to make compound cutting of various angles.

After an expected angle is reached, it is necessary to lock the pivot arm and/or the table prior to making the cut. To this end, a bevel lock device is generally mounted on the rear of the pivot arm. However, it is not always convenient for the operator to operate the bevel lock device on the rear of the pivot arm because of the generally big size of the miter saw. While it may be preferred to have the bevel lock device mounted on the table at the side near the operator, a miter lock device and a miter detent device are conventionally disposed at the bottom of the table and extend to the front side of the table near the operator. Furthermore, the miter saw typically includes sliding rods which support the pivot arm and sometimes may even have an extending table supporting rod and the sliding rods and supporting rod are also mounted at the bottom of the table. Accordingly, these elements make the overall structure very complicated and the space of the bottom of the table is badly limited. Still further, known bevel lock devices are usually operated in the axial direction, which is one of the reasons why the structures of locking/unlocking and the corresponding operation thereof are both limited.

### SUMMARY

The following describes a miter saw for which it is easy to lock the bevel angle thereof and has a simple locking structure. To this end, a described miter saw comprises a base, a table rotatably mounted on the base and having a supporting surface, a support mounted on the rear of the table; a pivot arm pivotably connected to the support through a connecting shaft, a cutting assembly connected to the pivot arm having a blade wherein a central axis of the connecting shaft lies approximately in the supporting surface of the table and which is approximately perpendicular to a rotation axis of the blade, a locking member connected between the support and the pivot arm, an electric member connected to the locking member through a linkage, and a switch electrically connected to the electric member. As will become apparent, due to using the electric member to lock or release the locking device, the locking device will be convenient to operate merely by turning on or turning off the switch. Furthermore, because the switch and the electric member are electrically connected, the switch could be disposed on any place of the miter saw for operation convenience.

Still further, the described miter saw may comprise a base, a table rotatably mounted on the base, and having a supporting surface, a support mounted on the rear of the table, a pivot arm pivotally connected to the support through a linkage, a cutting assembly connected to the pivot arm having a blade wherein a central axis of the linkage lies approximately in the supporting surface of the table and which is approximately perpendicular to a rotation axis of the blade, a locking member connected between the support and the pivot arm, and an operation rod protruding from a slot formed on the support and having an end connected to the locking member. In this embodiment, the operation rod is on the support, not on the rear end of the pivot arm. Therefore, the operation rod will be easy for an operator to reach and the operator will not need to reach towards a rear end of the machine. Compared with a conventional miter saw having the operation member on the front end of the saw, the described structure will be seen to be more compact.

The described miter say also includes an improved bevel lock device. More particularly, the bevel lock device comprises a clamp consisting of a first part and a second part wherein the first part is pivotal with one end thereof pivotal around a fixed pivot point and the other end thereof is pivotally connected to one end of a first rotation arm with the other end of the first rotation arm being an operation end. Such a bevel lock device will be seen to facilitate operation, and because of which, the whole bevel locking system of a miter saw will no longer need to be limited to the conventional axial locking mode or corresponding structures.

A better appreciation of the objects, advantages, features, properties, and relationships of the disclosed tool will be obtained from the following detailed description and accompanying drawings which set forth illustrative embodiments which are indicative of the various ways in which the principles described hereinafter may be employed

### BRIEF DESCRIPTION OF THE DRAWINGS

For use in better understanding the subject miter saw and bevel locking device described hereinafter reference may be had to the following drawings in which:

FIG. 1 is a perspective view of an exemplary miter saw constructed according to the present invention;

FIG. 2 is a partial bottom view of the exemplary miter saw showing a partial structure of a first exemplary bevel locking and unlocking device;

FIG. 3 is a sectional view of the exemplary miter saw showing the bevel locking and unlocking device of FIG. 2;

FIG. 4 is a partial bottom view of the exemplary miter saw showing a partial structure of a second exemplary bevel locking and unlocking device;

FIG. 5 is a partial section view of the exemplary miter showing the bevel locking and unlocking device of FIG. 4;

FIG. 6 is a perspective view of the pivot arm and the bevel locking and unlocking device of FIG. 4;

FIG. 7 is a perspective view of the exemplary miter saw showing an exemplary pivot arm and bevel lock device; and

FIG. 8 is a perspective view of the pivot arm and bevel lock device of FIG. 7.

### DETAILED DESCRIPTION

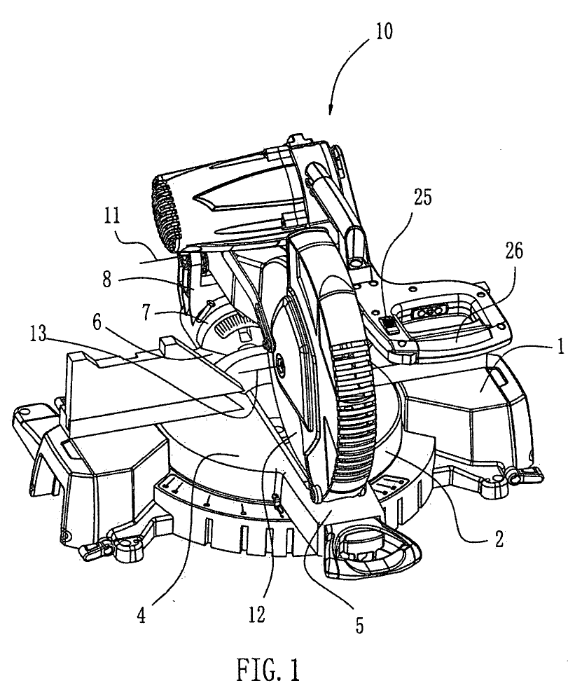

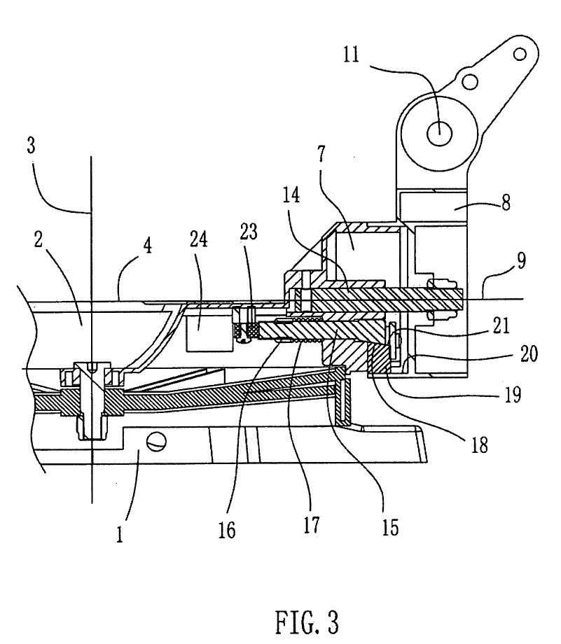

Referring to FIG. 1 and FIG. 3, a miter saw comprises a base 1 and a table 2 rotatably mounted on the base 1 around a center axis 3 thereof. The table 2 includes a supporting surface 4 for supporting a workpiece. The center axis 3 is perpendicular to the supporting surface 4. The table 2 comprises a front end 5 adjacent an operator and a rear end 6 opposing the front end 5. The rear end 6 has a support 7. A pivot arm 8 is connected to the support 7 through a connecting shaft 14 and is pivotal around a first axis 9. The first axis 9 is co-axial to a central axis of the connecting shaft 14. A cutting assembly 10 is connected to the pivot arm 8 and is pivotable around a second axis 11 between a lower cutting position and a higher at-rest position. The cutting assembly 10 includes a blade 12. The first axis 9 lies approximately on the supporting surface 4 of the table and is approximately perpendicular to a rotation axis 13 of the blade 12. The second axis 11 is approximately parallel to the rotation axis 13 of the blade 12.

The miter saw includes a bevel locking and unlocking device. The device is used for locking the pivot arm 8 relative to the table 2 so as to fix the blade 12 at a desired bevel angle relative to the supporting surface 4 of the table 2. The device is available to be unlocked so that the pivot arm 8 is able to rotate around the first axis 9 relative to the table 2.

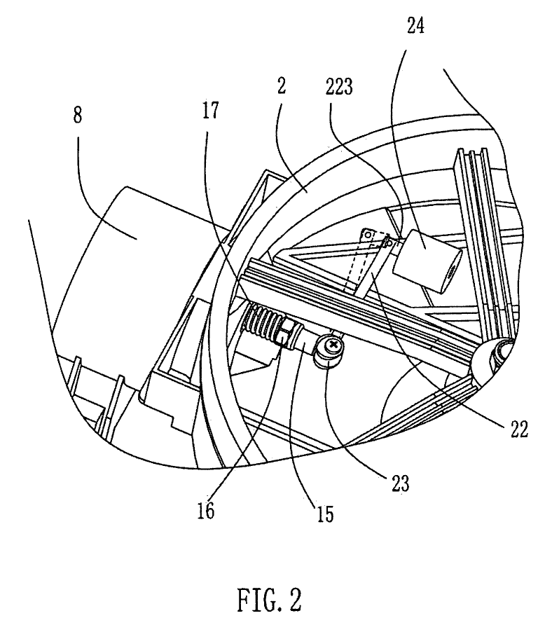

Referring to FIG. 2 and FIG. 3, as a first described embodiment, the bevel lock device comprises a locking shaft 15 which is approximately parallel to the connecting shaft 14. A nut 16 is fixed on the locking shaft 15. A spring 17 is biased between the nut 16 and the support 7. The locking shaft 15 has an inclined surface 18 at one end thereof. A press block 19 is disposed between an arcuate inner wall 20 of the pivot arm 8 and the locking shaft 15 and includes an inclined surface 21 cooperating with the inclined surface 18 of the locking shaft 15. With biasing of the spring 17, the locking shaft 15 tends to move towards the left as shown in FIG. 3. Therefore, the inclined surface 18 of the locking axis 15 presses against the inclined surface 21 of the press block 19 to push the press block 19, and subsequently the inner wall 20 of the pivot arm 8, to lock the pivot arm 8 in an expected position.

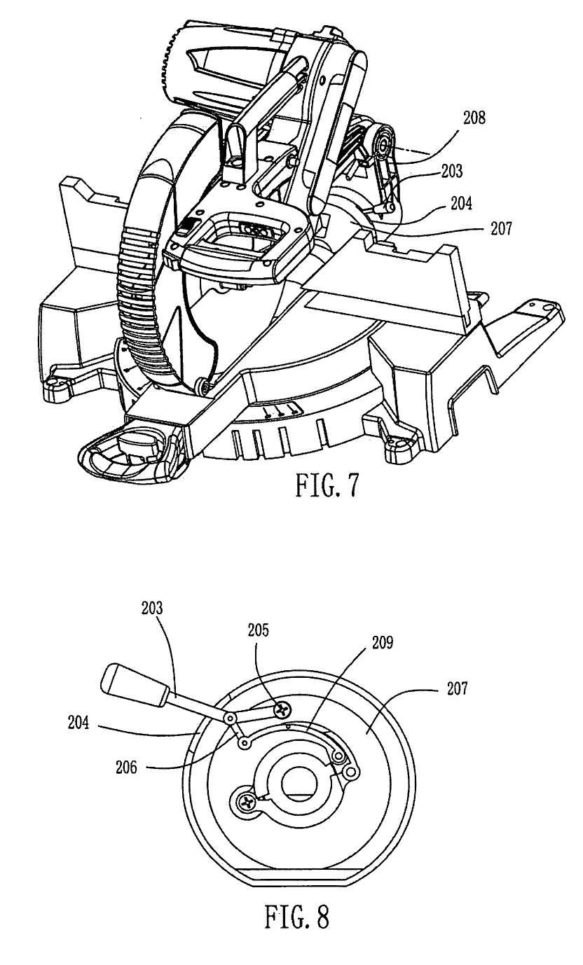

The bevel lock device also could follow anther structure described bellow which is usually used on a conventional miter saw. The locking shaft 15 goes through an arcuate slot formed on the pivot arm 8 and one end of the locking shaft 15 which protrudes out from the arcuate slot is fixed with a nut or a press block of other forms. Due to the biasing force of the spring 17, the locking shaft 15 drives the press block and, accordingly, the pivot arm 8 on the support 7 of the table, and thus the pivot arm 8 is fixed on the support 7 through a friction force therebetween. Such a locking mode is shown in FIG. 7 of U.S. Pat. No. 7,021,186 incorporated herein by reference in its entirety.

The bevel unlock device comprises a control rod 22, one end of which is fixed with a cam 23. The cam 23 is rotatably mounted on the table 2. The control rod 22 is made of metal or magnetic material, or at least the end thereof is mounted with a metal or magnetic member 223. An electro-magnet 24 is disposed in the table 2 and is electrically connected to a switch 25 mounted on the handle. Once the switch 25 is turned on, the electro-magnet 24 generates a magnetic force and the control rod 22 rotates to approach the electro-magnet 24, referring to FIG. 2 as shown by the solid lines. When the cam 23 is driven to rotate the cam 23 pushes the locking shaft 15, so that the locking shaft 15 releases the pressure on the press block 19. The pressure force of the press block 19 on the inner wall 20 of the pivot arm 8 will accordingly decreases or disappear such that the bevel angle of the pivot arm 8 relative to the table 2 is available to be adjusted. Once an expected angle is reached the switch 25 is turned off and the magnetic force of the electro-magnet 24 disappears. Due to the biasing force of the spring 17, the locking shaft 15 will move back to the initial position automatically and cam 23 and the control rod 22 will rotate to a position shown by the dotted line of FIG. 2.

It will be appreciated that other mechanisms can be used to realize control of the locking shaft 15 besides the shown locking shaft 15 that is pushed by the cam 23. Furthermore, it will be appreciated that, besides utilizing the pulling force of the electro-magnet 24 to control the locking axis 15, a repulsion force generated by the electro-magnet 24 could also be realized to lock or unlock the pivot arm.

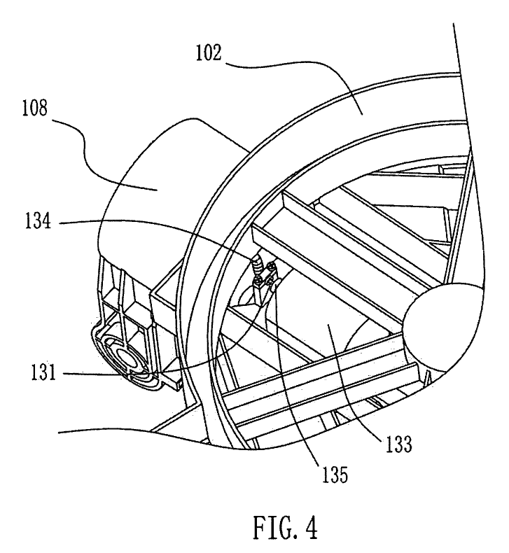

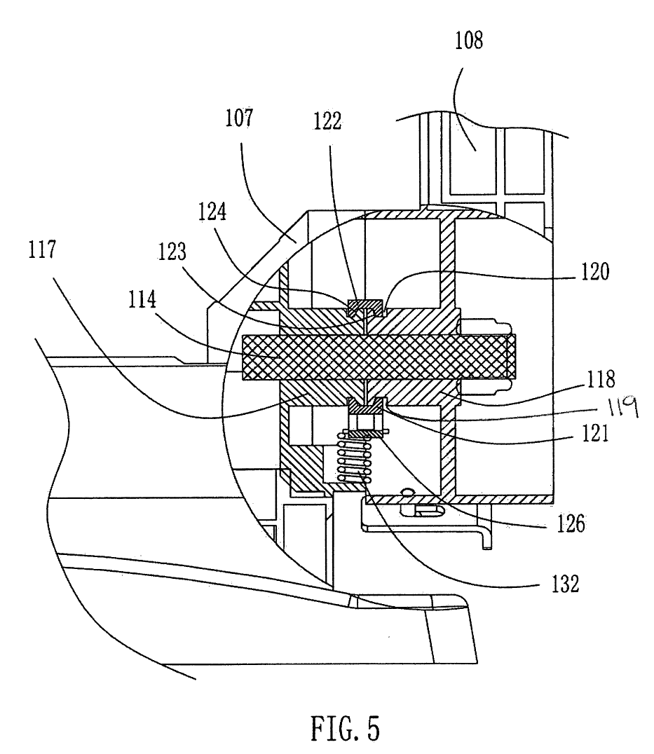

Referring to FIGS. 4-6 a second embodiment of a miter saw is described including a rotatable table, a support, and a pivot arm, each of which comprise a sleeve 117, 118 integrated therewith. In other embodiments, the sleeves 117, 118 could also be fixed on the support and the pivot arm through fixing means. A link shaft 114 goes through the sleeves 117,118. The pivot arm is pivotable around the link shaft 114 relative to the table. The sleeves 117,118 have a circumferential slot 119,120 respectively. A hoop consisted of a first part 121 and a second part 122 is embedded in the slot 119,120 in such a way that the sleeve 117 of the support and the sleeve 118 of the pivot arm are connected. The first part 121 and the second part 122 of the hoop have an inclined surface 123 which is engaged with an inclined surface 124 of the slot 119,120. When the first part 121 and the second part 122 are pressed towards each other, the sleeves 117, 118 are pushed to get connected because of the existence of the inclined surfaces. In such a way, the pivot arm 108 is locked through the friction force between the contacting surfaces of the pivot arm and the support. In other embodiments, only the hoop has an inclined surface or only the side wall of the slot is inclined.

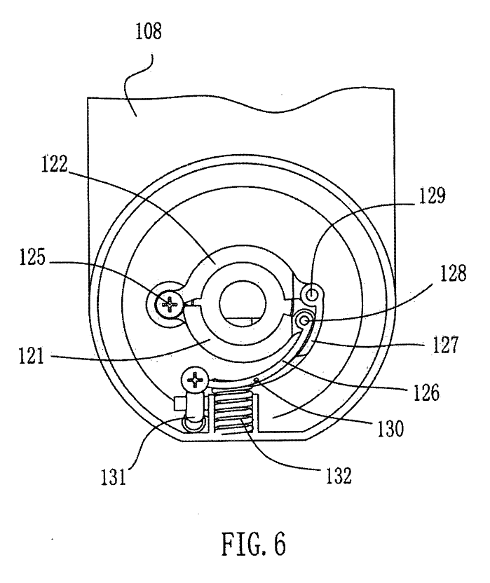

Referring to FIG. 6, the first part 121 and second part 122 of the hoop each has an end pivotable around a pivot 125. In other embodiments, the first part 121 and the second part 125 may also pivot around two different pivots respectively. The other end of the first part 121 of the hoop is pivotably connected to one end of a first rotation arm 126 through a first pivot shaft 128. The other end of the second part 122 of the hoop is pivotably connected to one end of a second rotation arm 127 through a second pivot shaft 129. The other end of the second rotation arm 127 is pivotably connected to a supporting point 130 in the middle of the first rotation axis 126. The other end of the first rotation arm 126 fixed to a soft connecter 131. A compression spring 132 is biased on the first rotation arm 126 at the part thereof that is closest to the end that is connected with the soft connecter 131. The compression spring 132 pushes the first rotation arm 126 upwardly so that the first part 121 and the second part 122 of the hoop approach each other and to thus press together the sleeve 117 of the support 107 and the sleeve 118 of the pivot arm 108.

When it is needed to adjust the bevel angle of the pivot arm 108, the switch 25 is first turn as discussed with reference to FIG. 1. An electro-magnet 133 generates a electromagnetic force to pull a metal or magnetic member 135 which is mounted on one end of the soft connecter 131. The soft axis 131 is thus pulled to drive the first rotation arm 126 to pivot downwardly. The first part 121 and the second part 122 of the hoop then depart from each other so that the pivot arm 108 is loosen to be able to be adjusted. In this embodiment, the soft connecter 131 is connected to the first rotation arm 126 and goes through a snake pipe 134 in which way the location and force direction of the electro-magnet 133 is relatively free and not limited. The soft connecter 131 may be a metal rope or other similar member which is easy to bend but with a suitable toughness and tensile intensity. The soft connecter 131 could also be replaced by a rigid shaft or a set of link rods.

The described bevel lock devices are unlocked by when the switch 25 is turned off such that the operation becomes very easy. Furthermore, the switch 25 is electrically connected to the magnets so that the positions of both are relatively independent and the switch 25 could be disposed anywhere on the machine that is convenient for operation. In the embodiment as shown in FIG. 1, the switch 25 is disposed adjacent the handle 26 of the miter saw which is very convenient for operation.

The magnets 24,133 described above could also be any other member as long as the member could generate electromagnetic force when power is provided. The member 223,135 could also be a portion of the magnet 24,133 and the member 223,135 makes axial movement because of the magnetic attraction or the magnetic repulsion. The control rod 22 or the soft connecter 131 may be fixedly connected to the member 223,135.

Besides the electromagnetic force being used for unlocking the device as descried above, it could also be used to lock two part of the machine. For example, the electromagnetic force could also be used between other members such as between the base 1 and the table 2. It will also be understood that the described electromagnetic lock device is similarly available for other power tools, especially for those bench power tools which usually have big size. The electromagnetic lock device is much more convenient for use when compared with conventional lock device.

Referring to FIG. 7 and FIG. 8 a third embodiment of the miter saw has a similar device for locking a pivot arm 208 as described above with respect to the second embodiment. The difference is that an operation rod 203 protrudes out from a slot 204 formed on a support 207 of a rotatable table. The operation rod 203 is pivotable around a fixed pivot point 205. One end of a link rod 206 is pivotably connected to the middle of the operation rod 203 and the other end thereof is pivotably connected to a first rotation arm 209 of the hoop. Therefore, to move the operation rod 203 about the pivot point would result in the hoop elements engaging or disengaging with each other such that locking or the unlocking of the pivot arm 208 is realized. The operation rod 203 is mounted on the support 207 of the table as shown in FIG. 7 since it will be convenient for operation from the front side of the table and the structure is compact and simple.

The above described preferred embodiments are intended to illuminate the principle of the present invention, but not to limit its scope. It can be easily understood by those skilled in the art that many other modifications and variations of these preferred embodiments will be apparent and may be made without departing from the spirit and the scope of the invention as defined in the following claims.

What is claimed is:

1. A miter saw, comprising:
a base;
a table rotatably mounted on the base and having a supporting surface;
a support mounted on a rear of the table;
a pivot arm pivotably connected to the support through a connecting shaft;
a cutting assembly connected to the pivot arm having a blade wherein a central axis of the connecting shaft lies approximately on a supporting surface of the table and is approximately perpendicular to a rotation axis of the blade;
a locking member connected between the support and the pivot arm for locking the pivot arm in a position relative to the support;
an electric member for causing operation of the locking member through a linkage; and
a switch electrically connected to the electric member for controlling an actuating supply of power to the electric member.

2. The miter saw as recited in claim 1, wherein the electric member is an electromagnetic member.

3. The miter saw as recited in claim 2, wherein the locking member is a shaft which is approximately parallel to the connecting shaft and comprising an elastic device that applies an axial force onto the locking member and wherein the linkage is a cam.

4. The miter saw as recited in claim 2, wherein the locking member is a clamp comprised of a first part and a second part and an elastic device applies a substantially radial force on the clamp.

5. The miter saw as recited in claim 4, wherein the first and second parts of the clamp are respectively pivotable with one end thereof being pivotal around a fixed pivot point, wherein the other end of the first part is pivotally connected to one end of a first rotation arm, and the other end of the second part is pivotally connected to one end of a second rotation arm, and the other end of the first rotation arm is pivotally connected to a point in the middle of the second rotation arm, and the other end of the second rotation arm is fixedly connected to the linkage, and the elastic device applies the force onto the second rotation arm.

6. The miter saw as recited in claim 1, wherein the linkage is a soft connecter.

7. The miter saw as recited in claim 6, wherein a pipe surrounds the soft connecter.

8. The miter saw as recited in claim 2, wherein the linkage comprises a material which is able to be attracted by the electromagnetic member.

9. A miter saw, comprising:
a base;
a table rotatably mounted on the base and having a supporting surface;
a support mounted on a rear of the table;
a pivot arm pivotally connected to the support through a linkage;
a cutting assembly connected to the pivot arm having a blade wherein a central axis of the linkage lies approximately on a supporting surface of the table and is approximately perpendicular to a rotation axis of the blade;
a locking member connected between the support and the pivot arm for locking the pivot arm in a position relative to the support; and
an operation rod protruding from a slot formed on the support and having an end connected to the locking member.

10. The miter saw as recited in claim 9, wherein the operation rod is pivotable around a fixed pivot point and a linking device pivotally connects to the middle of the operation rod and has an end pivotally connected to the locking member.

11. The miter saw as recited in claim 10, wherein the locking member is a clamp comprised of a first part and a second part and wherein the first and second parts of the clamp are respectively pivotable with one end thereof being pivotal around a fixed pivot point, wherein the other end of the first part is pivotally connected to one end of a first rotation arm, and the other end of the second part is pivotally connected to one end of a second rotation arm, and the other end of the first rotation arm is pivotally connected to a point in the middle of the second rotation arm.

12. A bevel lock device for locking two movable parts of a miter saw, comprising:
a clamp comprised of a first part and a second part wherein the first part is pivotal with one end thereof pivotal around a fixed pivot point and the other end thereof is pivotally connected to one end of a first rotation arm and the other end of the first rotation arm is an operation end.

13. The bevel lock device as recited in claim 12, wherein the second part of the clamp is pivotal with one end thereof pivotal around a fixed pivot point and the other end thereof is pivotally connected to one end of a second rotation arm and the other end of the second rotation arm is pivotally connected to a point in the middle of the first rotation arm.

14. The bevel lock device for a miter saw as recited in claim 12, wherein the miter saw comprises a rotatable table which has a support mounted on the rear end thereof and a pivot arm pivotally connected to the support through a connecting shaft wherein each of the support and the pivot arm has a sleeve and the connecting shaft gets through the sleeves, wherein each of the sleeve has a circumferential slot for receiving the clamp, and wherein the clamp and the slots respectively have contacting surfaces facing each other, and at least one of the contacting surfaces is inclined.
